(19) United States
(12) Patent Application Publication
(10) Pub. No.: US 2011/0102699 A1
(43) Pub. Date: May 5, 2011

(54) LIQUID CRYSTAL DISPLAY AND REPAIR METHOD THEREOF

(75) Inventor: Woon-yong Park, Gyeonggi-do (KR)

(73) Assignee: TOVIS CO., LTD., Incheon (KR)

(21) Appl. No.: 12/997,221

(22) PCT Filed: Jun. 8, 2009
(86) PCT No.: PCT/KR2009/003057

§ 371 Date: Dec. 9, 2010

(30) Foreign Application Priority Data
Jun. 9, 2008 (KR) 1020080053585

(51) Int. Cl. G02F 1/1333

(52) U.S. Cl. 349/54

(57) ABSTRACT

A liquid crystal display includes: a plurality of first signal lines; a plurality of second signal lines crossing with the first signal lines; a plurality of switching elements which are connected to one of the first signal lines and one of the second signal lines respectively; and a repair line crossing with at least a portion of the first signal lines. At least one third signal line of the first signal lines and the second signal lines is connected to the repair line and transmits a signal corresponding to an opened fourth signal line of the first signal lines. According to the present invention, even in case that a repair line is removed from at least portion of a liquid crystal display, cutting of a data line can be repaired.

### FIELD OF THE INVENTION

The present invention relates to a liquid crystal display and a repair method thereof.

### BACKGROUND ART

Generally, a liquid crystal display (LCD) includes two display panels and a liquid crystal layer disposed therebetween and having a dielectric anisotropy. An electric filed is formed in the liquid crystal layer, and a transmittance of light passing the liquid crystal layer is regulated by regulating amplitude of the electric field so as to obtain a desired image. Such a liquid crystal display is representative one of a flat panel display (FPD), and TFT-LCD which uses thin film transistor (TFT) as a switching element is widely used.

Generally, a plurality of display signal lines which cross with each other, i.e., gate lines and data lines are formed on the display panel to which thin film transistors are formed, and in a pixel area of matrix shape which is defined by crossing of gate lines and data lines, a plurality of thin film transistors and a pixel electrode are formed. The thin film transistor controls data signal which is transmitted through the data line by a data driving IC (integrated circuit) according to a gate signal which is transmitted through the gate line by a gate driving IC and transmits the same to the pixel electrode.

There are various causes which may cause the deterioration of production yield in a process of manufacturing a liquid crystal display, open defect of a data line which is connected from an output terminal of the data driving IC to an input terminal of respective thin film transistor to transmit image signals may be a substantial cause to deteriorate the production yield.

In one example of a method for solving this problem, repair lines crossing with display signal lines are formed outside a display area which is a set of pixel areas, and signals transmitted to the data lines are detoured around the display area through the repair lines. However, there may be no repair lines, and in such a case a measure for meeting open defects.

### DETAILED DESCRIPTION OF THE INVENTION

### Technical Problem

The present invention has been made in an effort to provide a liquid crystal display and a repair method thereof which can suitably repair a data line even in case that there are no repair lines.

### Technical Solution

An exemplary embodiment of the present invention provides a liquid crystal display including: a plurality of first signal lines; a plurality of second signal lines crossing with the first signal lines; a plurality of switching elements which are connected to one of the first signal lines and one of the second signal lines respectively; and a repair line crossing with at least a portion of the first signal lines. At least one third signal line of the first signal lines and the second signal lines is connected to the repair line and transmits a signal corresponding to a cut fourth signal line of the first signal lines.

The third signal line may be cut from a pad of the third signal line.

A portion of the repair line may be cut.

The third signal line may be connected to the fourth signal line.

The repair line may be connected to the fourth signal line.

The third signal line may include one of the first signal lines and one of the second signal lines which are connected to each other.

Another exemplary embodiment of the present invention provides a liquid crystal display including: a plurality of data lines; a plurality of gate lines crossing with the data lines; and a repair line at least a portion of which is cut. At least one of the gate lines is cut from a pad to which a signal from outside is input and is connected to an opened data line of the data lines and the repair line.

Yet another exemplary embodiment of the present invention provides a liquid crystal display including: a plurality of data lines; a plurality of gate lines crossing with the data lines; and a repair line at least a portion of which is cut. At least one of the data lines is cut from a pad to which a signal from outside is input and is connected to the repair line. The repair line is connected to an opened data line of the data lines.

Yet another exemplary embodiment of the present invention provides a liquid crystal display including: a plurality of data lines; a plurality of gate lines crossing with the data lines; and a repair line at least a portion of which is cut. At least one first gate line of the gate lines is cut from a gate pad to which a gate signal from outside is input and is connected to an opened data line of the data lines. At least one of the data lines is cut from a data pad to which a data signal from outside is input and is connected to the repair line and the first gate line.

An exemplary embodiment of the present invention provides a repair method of a liquid crystal display comprising a plurality of first signal lines, a plurality of second signal lines crossing with the first signal lines, a plurality of switching elements which are connected to one of the first signal lines and one of the second signal lines respectively, and a repair line crossing with at least a portion of the first signal lines, including: electrically connecting at least one third signal line of the first signal lines and the second signal lines to the repair line; and applying a signal equal to a signal applied to an opened fourth signal line of the first signal lines to the third signal line.

The repair method may further include cutting the third signal line from a pad of the third signal line.

The repair method may further include electrically connecting the third signal line and the fourth signal line to each other.

The repair method may further include electrically connecting the repair line and the fourth signal line to each other.

The repair method may further include electrically connecting one of the first signal lines which is included in the third signal line and one of the second signal lines to each other.

Another exemplary embodiment of the present invention provides a repair method of a liquid crystal display comprising a plurality of data lines, a plurality of gate lines crossing with the data lines, and a repair line at least a portion of which is cut, including: cutting at least one first gate line of the gate lines from a pad to which a signal from outside is input; and electrically connecting the first gate line to an opened data line of the data lines and the repair line.

Yet another exemplary embodiment of the present invention provides a repair method of a liquid crystal display comprising a plurality of data lines, a plurality of gate lines crossing with the data lines, and a repair line at least a portion of which is cut, including: cutting at least one first data line of the data lines from a pad to which a signal from outside is input; electrically connecting the first data line to the repair line; and electrically connecting the repair line to an opened data line of the data lines.

Yet another exemplary embodiment of the present invention provides a repair method of a liquid crystal display comprising a plurality of data lines, a plurality of gate lines crossing with the data lines, and a repair line at least a portion of which is cut, including: cutting at least one first gate line of the gate lines from a gate pad to which a gate signal from outside is input; electrically connecting the first gate line to an opened data line of the data lines; cutting at least one first data line of the data lines from a data pad to which a data signal from outside is input; and electrically connecting the first data line to the repair line and the first gate line.

### Advantageous Effects

As such, even in case that even in case that a repair line is removed from at least portion of a liquid crystal display, open defect of a data line can be repaired.

### BRIEF DESCRIPTIONS OF THE DRAWINGS

FIG. 1 is a top view of a liquid crystal display according to an exemplary embodiment of the present invention.

FIG. 2 is an equivalent circuit diagram of one pixel of a liquid crystal display according to an exemplary embodiment of the present invention.

FIG. 3 is a schematic view of a liquid crystal panel according to an exemplary embodiment of the present invention.

FIG. 4 is a sectional view of a liquid crystal display which is formed by cutting a liquid crystal display of FIG. 3 along one direction.

FIG. 5 to FIG. 8 are top views showing a method of repairing a data line of a liquid crystal display according to an exemplary embodiment of the present invention.

### BEST MODE

The present invention will now be described more fully hereinafter with reference to the accompanying drawings, in which preferred embodiments of the invention are shown.

In the drawings, the thickness of layers, films, panels, regions, etc. are exaggerated for clarity. Like reference numerals designate like elements throughout the specification. It will be understood that when an element such as a layer, film, region or substrate is referred to as being “on” another element, it can be directly on the other element or intervening elements may also be present. In contrast, when an element is referred to as being “directly on” another element, there are no intervening elements present.

A liquid crystal display and a repair method thereof according to an exemplary embodiment of the present invention will be described in detail with reference to the accompanied drawings.

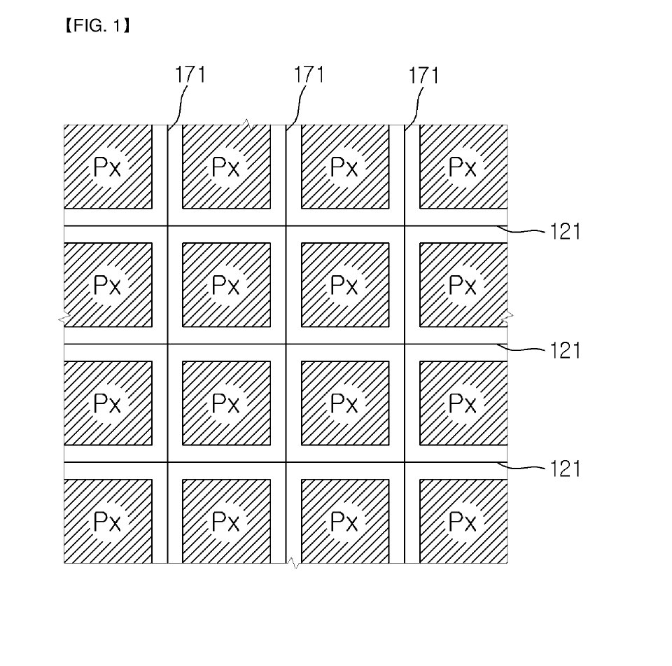

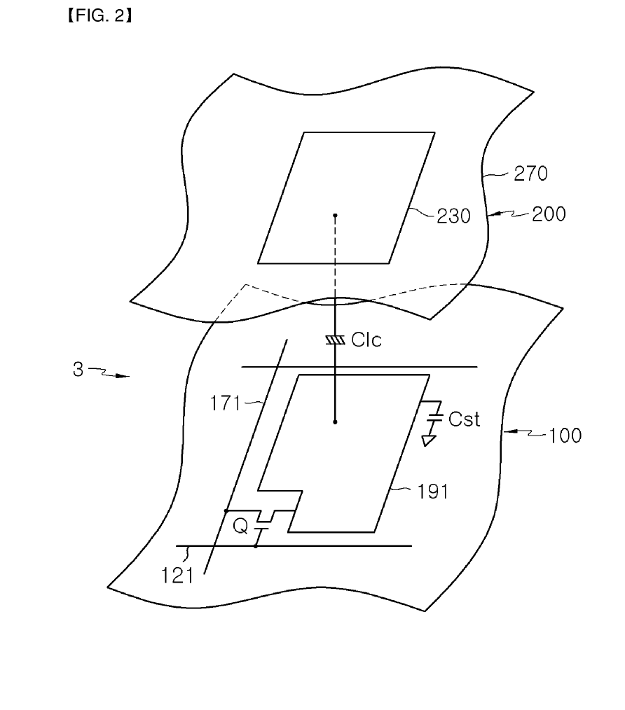

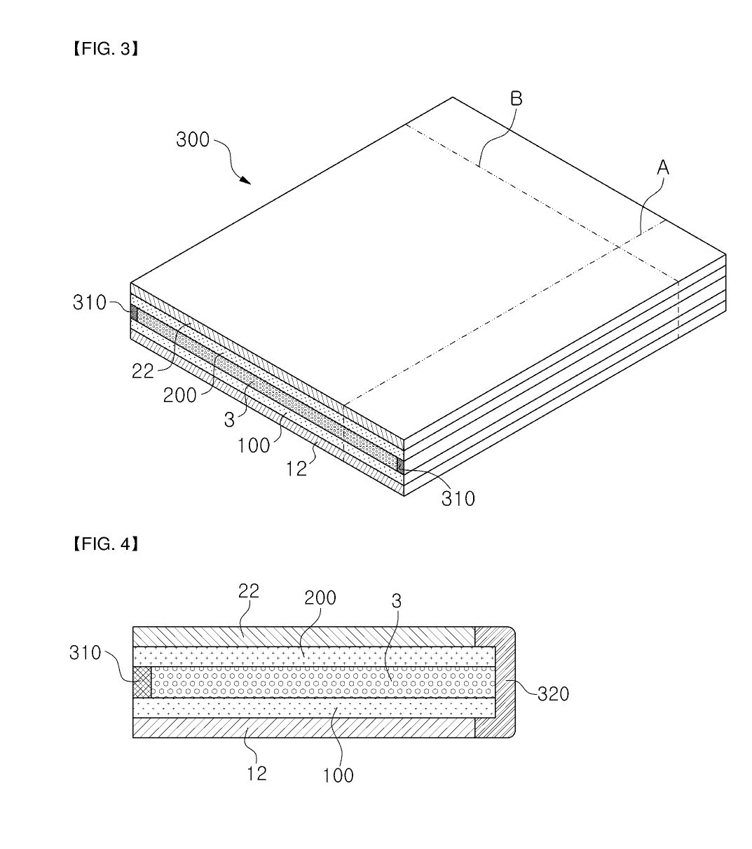

FIG. 1 is a top view of a liquid crystal display according to an exemplary embodiment of the present invention, FIG. 2 is an equivalent circuit diagram of one pixel of a liquid crystal display according to an exemplary embodiment of the present invention, and FIG. 3 is a schematic view of a liquid crystal panel according to an exemplary embodiment of the present invention.

As shown in FIG. 1, a liquid crystal display according to exemplary embodiment of the present invention includes a plurality of data lines 171 which substantially extend in a column direction and are substantially parallel with each other, gate lines 121 which substantially extend in a row direction and are substantially parallel with each other, and a plurality of pixels PX which are connected to lines 171 and 121 and are substantially arranged in a matrix shape. Meanwhile, in a structure shown in FIG. 2 and FIG. 3, liquid crystal panel assembly 300 includes lower and upper panels 100 and 200 which face each other, and a liquid crystal layer 3 which is interposed between panels 100 and 200 and includes liquid crystal molecules which are aligned vertically or horizontally. Lower panel 100 may be referred to as a thin film transistor array panel, and upper panel 200 may be referred to as a color filter array panel.

A sealant 310 which is made of material for bonding two panels 100 and 200 and defines a space which is filled with liquid crystal and prevents leak of liquid crystal is formed at edges of two panels 100 and 200, and polarizers 12 and 22 for polarizing light are respectively attached to outer surfaces of two panels 100 and 200. One of polarizers 12 and 22 may be omitted.

Each pixel PX includes a switching element Q connected to data line 171 and gate line 121, and a liquid crystal capacitor Clc and a storage capacitor Cst connected thereto. If necessary, storage capacitor Cst may be omitted.

Switching element Q is a three terminal element such as a thin film transistor, etc. provided to lower panel 100, a control terminal thereof is connected to gate line 121, an input terminal thereof is connected to data line 171, and an output terminal thereof is connected to liquid crystal capacitor Clc and storage capacitor Cst.

Liquid crystal capacitor Clc has two terminals of a pixel electrode 191 of lower panel 100 and a common electrode 270 of upper panel 200, and liquid crystal layer 3 between two electrodes 191 and 270 serves as a dielectric material. Pixel electrode 191 is connected to switching element Q, and common electrode 270 is formed on the entire surface of upper panel 200 and a common voltage is applied thereto. Storage capacitor Cst assists liquid crystal capacitor Clc and maintains the data voltage applied to pixel electrode 191 for a predetermined period.

Meanwhile, for realizing color display, each pixel PX uniquely displays one of primary colors (spatial division) or each pixel PX alternately displays primary colors (temporal division) as time lapses, and a desired color is recognized by a spatial and temporal sum of primary colors. Examples of primary colors include three primary colors including red, green, and blue. FIG. 2 shows an example of a spatial division, and in this example, each pixel PX has a color filter 230 for one of the primary colors in a region of upper panel 200 corresponding to pixel electrode 191. Unlike FIG. 2, color filter 230 may be formed above or below pixel electrode 191 of lower panel 100.

Difference between data voltage applied to pixel electrode 191 and common voltage applied to common electrode 270 is represented as charge voltage, i.e., pixel voltage. Liquid crystal molecules are aligned differently depending on the magnitude of pixel voltage, and accordingly polarization of light passing through liquid crystal layer 3 varied, and variation of polarization causes variation of transmittance of light according to polarizers 12 and 22.

A method of manufacturing a liquid crystal display having a desired size by cutting and forming the above-described liquid crystal display will be explained in detail with reference to FIG. 4 together with FIG. 3.

FIG. 4 is a sectional view of a liquid crystal display which is formed by cutting a liquid crystal display of FIG. 3 along one direction.

Referring to FIG. 3, liquid crystal display 300 may be cut along a cutting line A or a cutting line B according to the desired size. The cutting line A is parallel with gate line 121, and the cutting line B is parallel with data line 171. Cutting method can be applied in the same way whenever liquid crystal display 300 is cut in both directions.

At first, polarizers 12 and 22 of liquid crystal display 300 are stripped by a predetermined width along a direction A or B. If polarizers 12 and 22 are stripped, lower panel 100 and upper panel 200 are exposed. Subsequently, a cutting position is selected so as not to damage gate line 121 and data line 171 by inspecting exposed lower and upper panels 100 and 200 with a microscope or the like. Subsequently, a first scribe line is made to a center depth of upper panel 200 along the selected cutting position using a diamond wheel, a diamond needle, a laser or the like, and liquid crystal display 300 is turned over and a second scribe line is made to a center depth of lower panel 100 to be coincided with the first scribe line.

Upper panel 200 and lower panel 100 are steadied for about 30 minutes in a state that the scribe lines are formed. Natural crack is formed along the scribe lines formed in two panels 100 and 200 for steadying, so air is introduced into liquid crystal layer 3, and if air is introduced into liquid crystal layer 300, leak of liquid crystal layer 3 is temporarily restricted by the introduced air. After such a steadying step, if a predetermined force is applied from the outside, liquid crystal display 300 is cut along the scribe lines. A sealant 320 is covered on the cut portion so as to prevent leak of liquid crystal from the cut portion.

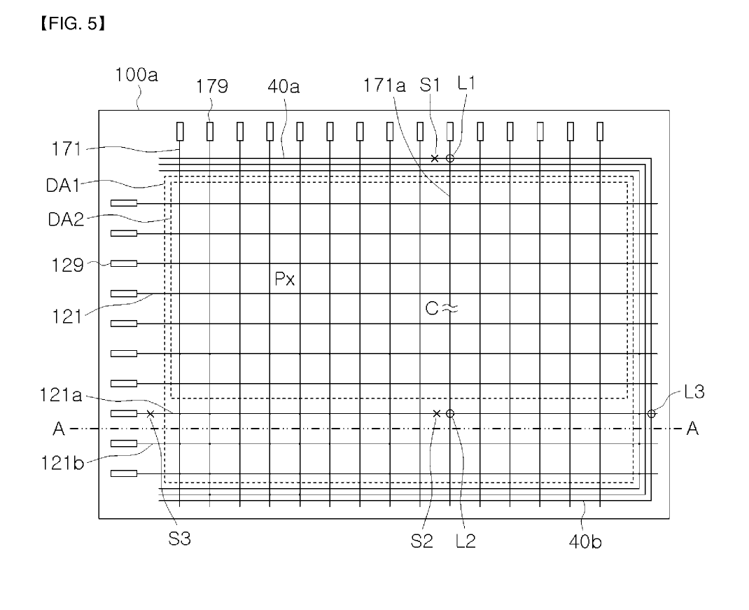

By performing these steps, a liquid crystal display having a desired size can be manufactured. However, in a liquid crystal display which is manufactured in this way, a portion of a repair line which is provided to repair data line 171 is simultaneously cut, so a method for repairing such a liquid crystal display will be explained using various examples with reference to FIG. 5 to FIG. 8.

FIG. 5 to FIG. 8 are top views showing a method of repairing a data line of a liquid crystal display according to an exemplary embodiment of the present invention.

A lower panel 100a of a liquid crystal display according to an exemplary embodiment of the present invention shown in FIG. 5 is an example for explaining a case in that a liquid crystal display shown in FIG. 3 is cut along a cutting line A.

On lower panel 100a, a plurality of gate lines 121 are formed along a horizontal direction and a plurality of data lines 171 are formed along a vertical direction. A gate pad 129 is formed at a left end of gate line 121, and a data pad 179 is formed at an upper end of data line 171. A gate driving IC and a data driving IC may be respectively provided to or a flexible printed circuit (FPC) may be attached to gate pad 129 and data pad 179. A plurality of pixels PX which is formed by cross of gate line 121 and data line 171 form a display area which is a portion for displaying images. Display area of liquid crystal display is DA1 before cutting but is DA2 after cutting.

Repair lines 40a and 40b which cross with gate line 121 and data line 171 in a state of being electrically insulated are formed in a □ shape, i.e., along upper, right, lower edges of lower panel 100a at the outside of display area DA1. However, if liquid crystal display is cut along a cutting line A which is disposed between gate lines 121a and 121b, gate lines 121b and repair lines 40b below the cutting line A are removed. Repair line 40a may be provided as a plural, and in FIG. 5, three repair lines 40a are exemplarily shown.

Meanwhile, although gate pad of gate line 121b are shown to be below the cutting line A, the gate pad may be over the cutting line A, and in this case, gate line 121b is turned toward the gate pad over the cutting line A to. At this time, since a liquid crystal display is cut along the cutting line A, gate line 121b outside the display area DA1 and the corresponding gate pad are remained without being removed.

Hereinafter, a method of repairing the opened data line 171a using repair line 40a and gate line 121a after cutting a liquid crystal display will be explained.

In case that data line 171a is opened at one point C, a point L1 and a point L2 where data line 171a crosses with repair line 40a and gate line 121a respectively are electrically connected using a laser (designated with a mark ‘∘’), and a point S1 of a repair line 40a and a point S2 of gate line 121a which are in the vicinity of the points which are electrically connected are cut so as not to occur unnecessary load (designated with a mark ‘x’). And a point L3 where repair line 40a and gate line 121a cross with each other is electrically connected using a laser.

Data signal is transmitted via data line 171a to the open point C of data line 171a, and below the open point C, data signal is transmitted via repair line 40a connecting points L1 and L3, gate line 121a connecting points L3 and L2, and data line 171a connecting point L2 and point below the open point C.

At this time, it is preferable to cut gate line 121a at a point near gate pad of gate line 121a outside of display area DA1. Accordingly, gate signal is not transmitted through gate line 121b, so it is prevented that unnecessary image is displayed on pixel PX connected to gate line 121b.

Gate line 121a for repair may preferably be in the vicinity of cutting line A, but is not necessarily to be directly on cutting line A, and may be provided as the same number with repair line 40a. For this, in cutting a liquid crystal display, cutting line A may be set to be larger than a desired size. Meanwhile, in case that other data line 171 except the repaired data line 171a is open, the opened data line 171 may be repaired in the same repair method described above by selecting repair line and gate line which are other than repair line 40a and gate line 121a which are used for repair of data line 171a.

Although repair line 40b is removed as a result of cutting of a liquid crystal display, the opened data line 171a can be repaired using gate line 121a, and using of gate line 121a for repairing the opened data line 171a does not affect on the manufacture of a liquid crystal display of a desired size.

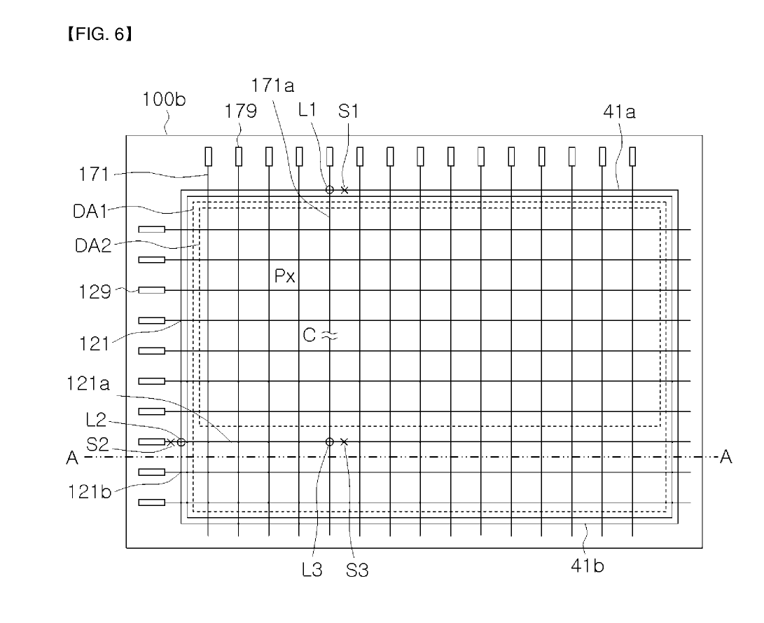

Subsequently, referring to FIG. 6, a lower panel 100b of a liquid crystal display according to an embodiment of the present invention shown in FIG. 6 is substantially equal to lower panel 100a shown in FIG. 5 but only different from the same in shape of repair lines 41a and 41b. Accordingly, to avoid repetition, description for the same will be omitted and description only for the different part will be made.

Repair lines 41a and 41b are formed in a ring shape, i.e., at an outside of display area DA1 along upper, lower, left and right edges of lower panel 100b.

In case that data line 171a is opened at one point C, a point L1 and a point L3 where data line 171a crosses with repair line 41a and gate line 121a respectively are electrically connected using a laser, and a point S1 of a repair line 41a and a point S3 of gate line 121a which are in the vicinity of the points which are electrically connected are cut so as not to occur unnecessary load (designated with a mark ‘x’). At this time, one of left and right, which makes repair line 41a shorter, is selected and cut. And a point L2 where repair line 41a and gate line 121a cross with each other is electrically connected using a laser, and cutting is performed between point L2 and a gate pad of gate line 121a.

Data signal is transmitted via data line 171a to the opened point C of data line 171a, and below the opened point C, data signal is transmitted via repair line 41a connecting points L1 and L2, gate line 121a connecting points L2 and L3, and data line 171a connecting point L3 and point below the opened point C.

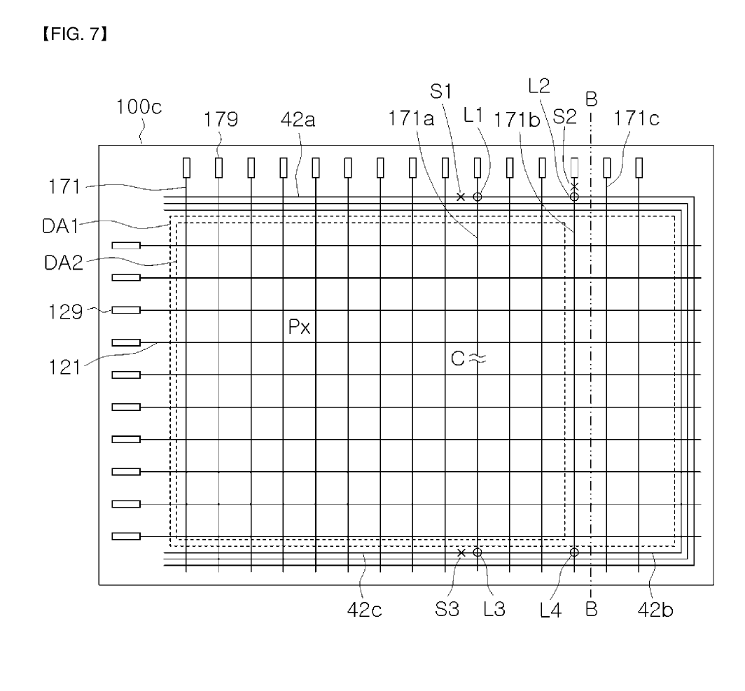

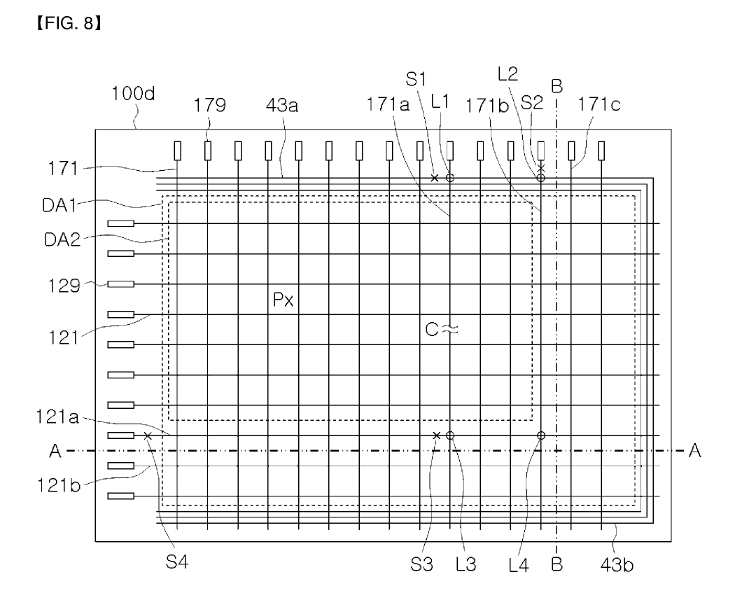

A lower panel 100c of a liquid crystal display according to an embodiment of the present invention shown in FIG. 7 is shown for explaining that a liquid crystal display shown in FIG. 3 is cut along a cutting line B. Accordingly, to avoid repetition, description for the same part will be omitted and description only for the different part will be made.

Repair lines 42a and 42b which cross with gate line 121 and data line 171 in a state of being electrically insulated are formed in a □ shape, i.e., along upper, right, lower edges of lower panel 100c at the outside of display area DA1. However, if liquid crystal display is cut along a cutting line B which is disposed between data lines 171b and 171c, data lines 171c and repair lines 42b on the right side of the cutting line B are removed, and repair line 42a and repair line 42c are separated from each other.

A method of repairing the opened data line 171a using repairs lines 42a and 42c and data line 171b after cutting a liquid crystal display will be explained.

In case that data line 171a is opened at one point C, a point L1 and a point L3 where data line 171a crosses with repair line 42a and repair line 42c respectively are electrically connected using a laser, and a point S1 of a repair line 42a and a point S3 of repair line 42c which are in the vicinity of the points L1 and L3 respectively are cut so as not to occur unnecessary load. And a point L2 and a point L4 where data line 171b crosses with repair line 42a and repair line 42c respectively are electrically connected using a laser. And data line 171b is cut at a point S2 which is in the vicinity of data pad of data line 171b outside of display area DA1 such that data signal transmitted to data line 171a and data signal transmitted to data line 171b are not overlapped.

Data signal is transmitted via data line 171a to the opened point C of data line 171a, and below the opened point C, data signal is transmitted via repair line 42a connecting points L1 and L2, data line 171b connecting points L2 and L4, repair line 42c connecting points L4 and L3, and data line 171a connecting point L3 and point below the opened point C.

Data line 171b for repair may preferably be in the vicinity of cutting line B, but is not necessarily to be directly at the left of cutting line B, and may be provided as the same number with repair line 42a. For this, in cutting a liquid crystal display, cutting line B may be set to be larger than a desired size. Meanwhile, in case that other data line 171 except the repaired data line 171a is opened, the opened data line 171 may be repaired in the same repair method described above by selecting repair line and data line which are other than repair lines 42a and 42c and data line 171b which are used for repair of data line 171a.

Although repair line 42b is removed as a result of cutting of a liquid crystal display, the opened data line 171a can be repaired using data line 171b, and using of data line 171b for repairing the opened data line 171a does not affect on the manufacture of a liquid crystal display of a desired size.

A lower panel 100d of a liquid crystal display according to an embodiment of the present invention shown in FIG. 8 is shown for explaining that a liquid crystal display shown in FIG. 3 is cut along cutting lines A and B. To avoid repetition, description for the same part will be omitted.

Repair lines 43a and 43b which cross with gate line 121 and data line 171 in a state of being electrically insulated are formed in a □ shape, i.e., along upper, right, lower edges of lower panel 100d at the outside of display area DA1. However, if liquid crystal display is cut along a cutting line A between gate lines 121a and 121b and along a cutting line B which is disposed between data lines 171b and 171c, gate line 121b below cutting line A and data line 171c and repair line 43b on the right side of the cutting line B are removed.

A method of repairing the opened data line 171a using repairs line 43a, gate line 121a, and data line 171b after cutting a liquid crystal display will be explained.

In case that data line 171a is opened at one point C, a point L1 and a point L3 where data line 171a crosses with repair line 43a and gate line 121a respectively are electrically connected using a laser, and a point S1 of a repair line 43a and a point S3 of gate line 121a which are in the vicinity of the points L1 and L3 are cut so as not to occur unnecessary load. And a point L2 and a point L4 where data line 171b crosses with repair line 43a and gate line 121a respectively are electrically connected using a laser. And data line 171b is cut at a point S2 which is in the vicinity of data pad of data line 171b outside of display area DA1 such that data signal transmitted to data line 171a and data signal transmitted to data line 171b are not overlapped, and at this time, gate line 121a is cut at a point S4 which is in the vicinity of gate pad of gate line 121a outside display area DA1.

Data signal is transmitted via data line 171a to the opened point C of data line 171a, and below the opened point C, data signal is transmitted via repair line 43a connecting points L1 and L2, data line 171b connecting points L2 and L4, gate line 121a connecting points L4 and L3, and data line 171a connecting point L3 and point below the opened point C.

Gate line 121a for repair may preferably be in the vicinity of cutting line A, but is not necessarily to be directly on cutting line A, and may be provided as the same number with repair line 40a. For this, in cutting a liquid crystal display, cutting line A may be set to be larger than a desired size. Similarly, data line 171b for repair may preferably be in the vicinity of cutting line B, but is not necessarily to be directly at the left of cutting line B, and may be provided as the same number with repair line 42a. For this, in cutting a liquid crystal display, cutting line B may be set to be larger than a desired size.

Meanwhile, in case that other data line 171 except the repaired data line 171a is opened, the opened data line 171 may be repaired in the same repair method described above by selecting repair line, gate line and data line which are other than repair line 43a, gate line 121a and data line 171b which are used for repair of data line 171a.

Although repair line 43b is removed as a result of cutting of a liquid crystal display, the opened data line 171a can be repaired using gate line 121a and data line 171b, and using of gate line 121a and data line 171b for repairing the opened data line 171a does not affect on the manufacture of a liquid crystal display of a desired size.

Although a shape of the repair line is described with an example of “□” shape or a ring shape, the repair line may have other various shapes or various paths, and in case that the repair line has other shape or path, the opened data line can be repaired by a repair method according to the present invention. In addition, although a case that a data line is opened is described, in case that a gate line is opened, the opened gate line can be repaired by a repair method according to the present invention. A liquid crystal display according to an embodiment of the present invention may have, if necessary, amplifier, and may amplify data signal passing through a repair line.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A liquid crystal display comprising:
a plurality of first signal lines;
a plurality of second signal lines crossing with the first signal lines;
a plurality of switching elements which are connected to one of the first signal lines and one of the second signal lines respectively; and
a repair line crossing with at least a portion of the first signal lines,
wherein at least one third signal line of the first signal lines and the second signal lines is connected to the repair line and transmits a signal corresponding to an opened fourth signal line of the first signal lines.

2. The liquid crystal display of claim 1, wherein the third signal line is cut from a pad of the third signal line.

3. The liquid crystal display of claim 1, wherein a portion of the repair line is cut.

4. The liquid crystal display of claim 1, wherein the third signal line is connected to the fourth signal line.

5. The liquid crystal display of claim 1, wherein the repair line is connected to the fourth signal line.

6. The liquid crystal display of claim 1, wherein the third signal line comprises one of the first signal lines and one of the second signal lines which are connected to each other.

7. A liquid crystal display comprising:
a plurality of data lines;
a plurality of gate lines crossing with the data lines; and
a repair line at least a portion of which is cut,
wherein at least one of the gate lines is cut from a pad to which a signal from outside is input and is connected to an opened data line of the data lines and the repair line.

8. A liquid crystal display comprising:
a plurality of data lines;
a plurality of gate lines crossing with the data lines; and
a repair line at least a portion of which is cut,
wherein at least one of the data lines is cut from a pad to which a signal from outside is input and is connected to the repair line,
and wherein the repair line is connected to an opened data line of the data lines.

9. A liquid crystal display comprising:
a plurality of data lines;
a plurality of gate lines crossing with the data lines; and
a repair line at least a portion of which is cut,
wherein at least one first gate line of the gate lines is cut from a gate pad to which a gate signal from outside is input and is connected to an opened data line of the data lines,
and wherein at least one of the data lines is cut from a data pad to which a data signal from outside is input and is connected to the repair line and the first gate line.

10. A repair method of a liquid crystal display comprising a plurality of first signal lines, a plurality of second signal lines crossing with the first signal lines, a plurality of switching elements which are connected to one of the first signal lines and one of the second signal lines respectively, and a repair line crossing with at least a portion of the first signal lines, comprising:
electrically connecting at least one third signal line of the first signal lines and the second signal lines to the repair line; and
applying a signal equal to a signal applied to an opened fourth signal line of the first signal lines to the third signal line.

11. The repair method of claim 10, further comprising cutting the third signal line from a pad of the third signal line.

12. The repair method of claim 10, further comprising electrically connecting the third signal line and the fourth signal line to each other.

13. The repair method of claim 10, further comprising electrically connecting the repair line and the fourth signal line to each other.

14. The repair method of claim 10, further comprising electrically connecting one of the first signal lines which is included in the third signal line and one of the second signal lines to each other.

15. A repair method of a liquid crystal display comprising a plurality of data lines, a plurality of gate lines crossing with the data lines, and a repair line at least a portion of which is cut, comprising:
cutting at least one first gate line of the gate lines from a pad to which a signal from outside is input; and
electrically connecting the first gate line to an opened data line of the data lines and the repair line.

16. A repair method of a liquid crystal display comprising a plurality of data lines, a plurality of gate lines crossing with the data lines, and a repair line at least a portion of which is cut, comprising:
cutting at least one first data line of the data lines from a pad to which a signal from outside is input;
electrically connecting the first data line to the repair line; and
electrically connecting the repair line to an opened data line of the data lines.

17. A repair method of a liquid crystal display comprising a plurality of data lines, a plurality of gate lines crossing with the data lines, and a repair line at least a portion of which is cut, comprising:
cutting at least one first gate line of the gate lines from a gate pad to which a gate signal from outside is input;
electrically connecting the first gate line to an opened data line of the data lines;
cutting at least one first data line of the data lines from a data pad to which a data signal from outside is input; and
electrically connecting the first data line to the repair line and the first gate line.
